(19) United States
(12) Patent Application Publication
(10) Pub. No.: US 2004/0244996 A1
(43) Pub. Date: Dec. 9, 2004

(54) Firefighting water delivery system and method

(76) Inventor: Alexander I. Kravkov, Beaverton, OR (US)

Correspondence Address: NORTHWEST IP LAW GROUP, P. O. BOX 3703, PORTLAND, OR, 97208-3703, US

(21) Appl. No.: 10/850,923

(22) Filed: May 21, 2004

Related U.S. Application Data
(60) Provisional application No. 60/472,251, filed on May 21, 2003.

(51) Int. Cl. A62C 35/00

(52) U.S. Cl. 169/5

(57) ABSTRACT

Embodiments of the present invention provide a firefighting system able to supply a continuous flow of water to remote locations over great distances with varied terrains and conditions. The system can encompass multiple independent units, or reservoir assemblies each including portable water storage reservoirs with special design connections, conduits such as standard fire hoses, and pumps to induce the water flow as required. Each reservoir assembly unit represents a part of an integral system, a purpose of which is to transport water used in extinguishing fires from a water source where water is plentiful (such as, for example, a river, lake, or well) to the fire site, which can be at a remote location where it is difficult or expensive to supply water using traditional means.

### RELATED APPLICATIONS

This application is a nonprovisional application of U.S. Provisional Patent Application No. 60/472,251, filed May 21, 2003, which is hereby incorporated by reference in its entirety.

### COPYRIGHT NOTICE

©2004 Alexander I. Kravkov. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR § 1.71(d), (e).

### TECHNICAL FIELD

The present invention relates to portable, modular fire units designed to be interconnected for delivering a high volume of water, or other fire suppression fluid, to remote locations over long distances and varied terrains. Embodiments of the present invention are intended for the use of fighting fires and satisfying other water needs.

### BACKGROUND OF THE INVENTION

The problem of forest fires is a pressing one. Forest fires have global ecological implications. Each year countless acres of forest are destroyed by fires. Firefighters are faced with fighting hundreds, if not thousands, forest fires, and tens of thousands of firefighters are engaged in these activities. Unfortunately, each year numerous firefighters lose their lives combating forest fires.

Typical methods of battling forest fires include provisioning firefighters on the fire's front line, which can be very dangerous. Helicopters and planes are used to collect water from bodies of water and drop it on the fire. Unfortunately, the closest body of water may be some distance away from the fire or difficult to reach by aircraft. Precious time is lost sending the helicopter or plane back and forth to the water body for refilling.

While there are portable water storage tanks commercially available, such as those offered by the Fol-Da-Tank Co. of Milan, Ill., these units have never been able to be effectively integrated into a comprehensive system for delivering water over large distances to remote areas. They are typically used only for water shuttle or storage at one location. For example, they are frequently used in areas where water is available, but at low-pressure conditions that make it difficult to use most firefighting equipment. Additionally, the known prior art water storage tanks only include one port built into the tank. This port is typically used to purge the tank of stored water. In some instances, the port can be used to connect a second tank, but there is no convenient way to combine additional tanks to provide a larger aggregate volume of stored water. Because of the extreme intensity of many forest fires, the volume of water stored by one or two of even the largest portable units existing today would be ineffective in battling the blazes.

Embodiments of the present invention solve these problems. When embodiments of the present invention are used in addition to the current methods of battling fires, firefighters would be much more effective in fighting forest fires. As described in this application, implementing the invention would shorten the time of fighting a fire by making the endeavor more efficient. This would result in saving human life and conserving natural resources, thus allowing for the solution of some global ecological problems.

### SUMMARY OF THE INVENTION

The present application describes embodiments of a firefighting system able to supply a continuous flow of water to remote locations over great distances and varied terrains. The system can encompass multiple independent units, or reservoir assemblies each including portable water storage reservoirs with special design connections, conduits such as standard fire hoses, and pumps to induce the water flow as required. Each reservoir assembly unit represents a part of an integral system, a purpose of which is to transport water used in extinguishing fires from a water source where water is plentiful (such as, for example, a river, lake, or well) to the fire site, which can be at a remote location where it is difficult or prohibitively expensive to supply water using traditional means.

This application includes a system of interconnected reservoir assemblies. Each reservoir assembly, or unit, can be composed of a modular system of portable reservoirs, which allows for the accumulation of large quantities of water at any of several potential intermediate points along a given route from a water source to a remote fire site. Large numbers of reservoirs can be interconnected to provide a large aggregate volume of stored water at a location, but the individual reservoirs can be small enough to allow convenient placement in locations or topographies where larger single units could not be placed. Reservoirs can be placed on hiking paths, roads, small forest clearings, or other generally flat surfaces located along a route to the place of the fire.

The portable reservoirs of the present application can be transported using helicopters, which allows speedy unfolding of the system even to places that are hard to reach. Once delivered to the intended location, the reservoirs can be set up and connected. Because the reservoirs can be made small and affordable, reservoirs can even be provisioned at locations where a fire has yet to break out, but may ignite in the future. The water flow can then be conveyed to that location if the fire path changes. This allows firefighters to stay ahead of a forest fire, even if the fire's advancing front changes direction in unexpected ways. The firefighting system of this application adopts a modular design, allowing for an ongoing supply of large amounts of water to remote fires. It is expected that embodiments of the present invention can supply in excess of 100 gallons of water per second to remote locations, thus solving many technical problems that arise when fighting forest fires of almost any magnitude and severity.

Additional aspects and advantages of this invention will be apparent from the following detailed description of preferred embodiments, which proceeds with reference to the accompanying drawings.

### BRIEF DESCRIPTION OF THE DRAWINGS

FIG. 1 illustrates a water delivery system of the present invention, providing step-by-step transportation of water from a water source to a remote fire location.

FIG. 2 is a side view of a preferred embodiment of a portable water reservoir for comprising a water reservoir assembly unit in the system of FIG. 1.

FIG. 3 presents an isometric view of the portable reservoir of FIG. 2.

### DETAILED DESCRIPTION OF PREFERRED EMBODIMENTS

The present application discloses a system that can solve many problems encountered in fighting severe forest fires, by delivering a continual flow of a liquid, such as water, in practically unlimited quantities to a desired area, even if the area is remote and difficult to access (such as at remote wilderness locations, inside of coal mines, etc.).

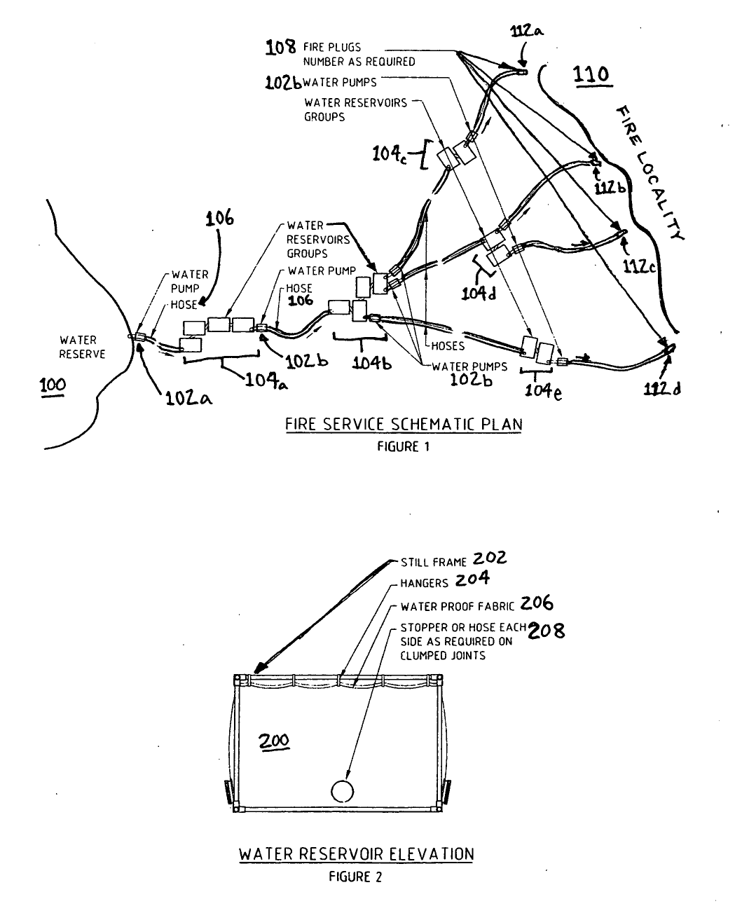

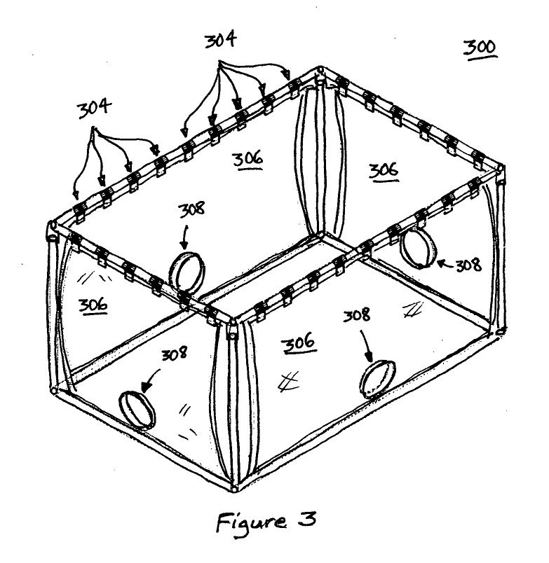

FIG. 1 illustrates a preferred embodiment of the firefighting system. As presently preferred, the system encompasses an interconnected grouping of reservoir assemblies, or units, with each unit being comprised of one or more interconnected, portable water reservoirs, such as the one illustrated in FIG. 2 and FIG. 3.

With particular reference to FIG. 1, a preferred system conveys water from a water reservoir 100 to one or more fire plugs or nozzles 112a-112d at a fire site 110. The system includes reservoir assemblies, or groups of reservoirs 104a-104e positioned at intermediate locations between the water source 100 and the fire site 110. The number and configuration of water reservoirs in each reservoir assembly 104a-104e can be varied, depending on the location topography and conditions, and the volume of water necessary to provide a sufficient flow rate at each fire plug or nozzle 112a-112d at the fire site 110.

Each reservoir assembly can be connected with conduit 106 to enable the flow of water to the desired location. The preferred conduit is commercially available fire hose 106 designed for use in forest fire applications. In certain applications, other forms of conduits, such as channels or fixed piping could alternatively or additionally be used.

Pumps 102a & 102b can also be provided to induce flow from the water source 100, through the reservoir assemblies 104a-104e and to the fire site 110. An initial pump 102a draws water from the water source and supplies it to a first reservoir assembly 104a. Additional pumps 102b can be provided as necessary throughout the system to meet the flow requirements for conveying water from one reservoir assembly (e.g., 104b) to the next assembly (e.g., 104c-104e), and for delivering the desired amount of water to the fire site 110 through one or more fire plugs or nozzles 112a-112d. The pumps can be operated via wireless control from a remote location so that pumping characteristics or paths can be varied from a safe distance, without having to send a firefighter into the fire zone to manually adjust a pump 102a & 102b.

The fire plugs or nozzles 112a-112d at the fire site can be provided as sprinkler nozzles so that water can be distributed automatically at the fire site 110 without the need for a human operator being present. This helps reduce the risk of injury or death to firefighters. It also allows the system to provide preventative watering of areas where a fire is not yet burning, in order to prevent the fire from spreading to that location. For example, in a remote location where wildfires can threaten homes, each homeowner can store one or more of the portable reservoirs at their house. When a wildfire threat is present, the reservoirs can be connected to the system and water from the water source can keep the reservoirs full and supply adequate water to a sprinkler nozzle being used to continually douse the homeowner's property, even if the homeowner has evacuated and no firefighters are present.

The modular nature of the system provides infinite flexibility in battling fires, which are dynamic in nature and frequently unpredictable. Those skilled in the art will readily recognize the advantages afforded by being able to select components to meet the particular water flow needs for a given application. For example, by including several water reservoir assemblies 104a-104e over a geographic expanse, smaller individual hoses 106 and smaller capacity pumps 102a & 102b can be used. Hoses can have diameters of less than three inches, and sometimes even an inch or less. Pumps 102a & 102b can be small gas operated pumps, because they only have to transport water over limited distances.

Those skilled in the art will readily recognize the relationship between the hose size and length, storage capacity of the reservoir assemblies, and pumping capacity of the pumps. The goal is provide a sufficient supply of water to the fire site 110. The paths to get there from the water source 100 can be practically infinite, and the presently disclosed firefighting system provides an equally flexible range of possible configurations. The size and number of the reservoirs, location and aggregate volume of the reservoir assemblies, capacity and operation of the pumps, and size and length of the hoses can all be selected and controlled to provide a desired quantity and constant flow of water from the water source 100 to the fire site 110 at the required locations 112a-112d.

The flexible, modular design of the water supply system also allows firefighters to adjust the water delivery to meet the changing requirements of the fire. For example, water from the water source 100 can be supplied through the first reservoir assembly group 104a and to the second reservoir assembly group 104b. If the fire site 110 only encompasses locations 112a-112c, a continual flow of water does not have to be provided through reservoir assembly 104e. If the fire spreads, the pump 102b from reservoir assembly 104e can be activated to supply water to the nozzle 112d. Operation of the pumps 102a & 102b in the system can be controlled (manually or remotely via a wireless connection) to provide water flow when and where it is needed. Following standard principles of hydrodynamics ensures that continuity of flow is preserved and help prevent component of the system from running dry unexpectedly.

Because many components are combined to provide the water distribution system with a significant cumulative capacity, the individual components can be selected so as to be small, for easy storage and transport, and inexpensive. Because water can be made available in practically unlimited quantities, the reservoir assemblies can be set up in a web throughout a fire zone. This allows the system to be used not just to attack a fire directly, but to contain it in a given location and prevent its further spread. If components are damaged in the fire, they can be easily and inexpensively replaced.

FIG. 2 illustrates a side view of a preferred portable reservoir in the present application. A plurality of water reservoirs 200 can be combined to form a reservoir assembly unit 104a-104e as shown of FIG. 1.

With particular reference to FIG. 2, the portable reservoir 200 comprises a generally rigid still frame 202 that can be collapsed or disassembled for storage or transport. A section of waterproof fabric 206, made of canvas, PVC or various other plastic or other waterproof materials, is supported on the frame 202 by a series of hangers 204. The hangers can be separate from the frame 202 and fabric 206, or they can be integrated into the frame 202 or fabric 206 (such as with an eye and hook coupling). Every reservoir can be easily assembled on threaded screwing elements (such as, for example, pipes, rods, or rebar). Additionally, straight or hinged sections of piping such as steel or aluminum tubing can be connected with fixed or removable corner connectors providing male-female couplings to hold the frame 202 in its assembled configuration of FIG. 2.

In a preferred application, the reservoir 200 comprises a generally rectangular polyhedron. Each of the vertically planar sides of the reservoir 200 is preferred to have a connection port 208. The connection ports allow multiple reservoirs 200 to be connected together in numerous ways using all available sides. Providing multiple connection ports on the reservoir in varied locations allows for numerous reservoirs 200 to be combined in many different configurations (such as those illustrated in FIG. 1). It is preferred that the connection ports are sized with a diameter larger than the typical hose 106 used to draw water from a pool. This allows for water to easily flow from one connected reservoir 200 to another faster than the rate at which the water is pumped from the reservoir. Port diameters of ten inches can provide sufficient flow.

The reservoir 200 of FIG. 2 can also include one or more one-way valves to establish unidirectional flow between connected reservoirs in a reservoir assembly or at a pump connection. The one-way valve can be integrated into the connection port, or it can be provided as a separate component installed between two connected reservoirs or at a pump. Employing a one-way valve allows pumps to draw from the reservoirs 200 efficiently and the reservoirs 200 can be connected even on hillsides or sloped grades without having to worry about backflow significantly hindering the performance of the system.

FIG. 3 illustrates a preferred embodiment of the portable reservoir of FIG. 2 in isometric view. As shown in FIG. 3, the waterproof fabric 306 is suspended on the rigid frame 302 by several hangers 304. FIG. 3 also illustrates four connection ports 308 integrated into the waterproof fabric 306 of the portable reservoir 300.

It will be obvious to those having skill in the art that many changes may be made to the details of the above-described embodiments without departing from the underlying principles of the invention. The scope of the present invention should, therefore, be determined only by the following claims.

1. A firefighting water delivery system for supplying continuous, large quantities of water from a water source at a first location to a fire site at a second location, the second location being dispersed from the first location, the system comprising:
a reservoir assembly provisioned at an intermediate location along a route from a water source at a first location to a fire site at a second location, wherein the second location is remote from the water source at the first location;
a first conduit connecting the water source and the reservoir assembly to convey water from the first location to the intermediate location for temporary storage in the reservoir assembly; and
a second conduit connecting the reservoir assembly and the fire site to convey water from the intermediate location to the second location for application at the fire site.

2. The system of claim 1 wherein the reservoir assembly includes one or more portable reservoirs interconnected so as to provide an aggregate volume of water in the reservoir assembly.

3. The system of claim 2, wherein each of the interconnected reservoirs includes at least one connection portal for connecting the reservoir to at least one other reservoir in the reservoir assembly so that the aggregate volume of water in the reservoir assembly can flow between the one or more reservoirs.

4. The system of claim 3 wherein each portable reservoir is rectangular and includes a connection portal on each vertically disposed planar surface.

5. The system of claim 2 wherein the one or more portable reservoirs include waterproof fabric suspended upon a generally rigid support frame to hold a volume of water.

6. The system of claim 2 wherein the interconnected reservoirs are connected by one-way valves to permit water flow in single direction between two interconnected reservoirs.

7. The system of claim 1 further comprising:
a first pump controlling flow through the first conduit; and
a second pump controlling flow through the second conduit; and
wherein the first and second pumps can be operated independently so as to deliver a desired volume of water from the water source to the fire site on a continuous basis.

8. The system of claim 7 further comprising a controller for regulating the first and second pumps.

9. The system of claim 8 wherein the controller regulates the first and second pumps wirelessly.

10. The system of claim 1 further comprising a sprinkler nozzle disposed at the second location and connected to the second conduit so as to distribute water at the fire site without ongoing human operation.

11. A firefighting system for conveying continuous quantities of water to remote locations, comprising:
a water source at a first location remote from a fire site at a terminal location;
at least one reservoir assembly placed at one or more intermediate locations selected along a route from the water source to the fire site; and
one or more conduits connecting the water source and reservoir assemblies to establish a continuous supply chain for conveying water from the water source to the fire site.

12. The system of claim 11 wherein the intermediate locations are selected so that the route includes a plurality of reservoir assemblies connected in parallel.

13. The system of claim 11 wherein the intermediate locations are selected so that the route includes a plurality of reservoir assemblies connected in series.

14. The system of claim 11 wherein the intermediate locations are selected so that the route includes a plurality of reservoir assemblies connected in both parallel and series.

15. The system of claim 11 further comprising a second fire site at a second terminal location; wherein the intermediate locations are selected so that the conduits establish the supply chain to convey water from the water source to both the first fire site and second fire site.

16. The system of claim 15 further comprising at least one controller for regulating the flow of water through the conduits to supply water to the first site and second site independently.

17. The system of claim 11 further comprising:
wirelessly controlled pumps to induce flow through the conduits;
a wireless controller for regulating the flow through the conduits based on water demand at the fire site.

18. The system of claim 11 wherein each reservoir assembly includes a plurality of portable reservoirs.

19. The system of claim 18 wherein the portable reservoirs can be collapsed for easy transport to or from the intermediate site.

20. The system of claim 19 wherein the portable reservoirs are sized so as to be transported by helicopter.

21. The system of claim 18 wherein the reservoirs include waterproof fabric suspended on a substantially rigid frame structure.

22. The system of claim 18 wherein each reservoir includes at least one connection portal to connect the reservoir to at least one other reservoir among the plurality of reservoirs in the reservoir assembly.

23. The system of claim 18 wherein the reservoirs are connected with one way valves permitting unidirectional flow between connected reservoirs in the reservoir assembly.

24. The system of claim 11 wherein the conduits are fire hoses.

25. The system of claim 11 wherein the conduits are channels.

26. A method for supplying water from a water source to a fire site at a remote location, the method comprising the steps of:
provisioning a reservoir assembly at each of one or more intermediate locations along a route from a water source to a remote fire site;
interconnecting the reservoir assemblies with conduit to enable water flow between reservoir assemblies;
supplying water from the water source to the interconnected reservoir assemblies to provide the reservoir assemblies with a persistent supply of water; and
conveying water through interconnected reservoir assemblies to the fire site.

27. The method of claim 26 further comprising the step of providing a plurality of pumps to establish water flow from the water source through the interconnected reservoir assemblies, and to the fire site, whereby water can be supplied to the remote fire site on a substantially continual basis.

28. The method of claim 27 wherein the pumps are operated wirelessly.

29. The method of claim 26 wherein the reservoir assemblies can be interconnected to provide water flow in series, in parallel, or in a combination of series and parallel.

30. The method of claim 26 wherein provisioning the reservoir assemblies includes assembling one or more portable reservoirs to provide a desired aggregate water storage capacity at the corresponding intermediate location.

31. The method of claim 26 wherein the step of conveying water to the fire site further includes the steps of:
provisioning a sprinkler nozzle at the fire site; and
conveying the water from the interconnected reservoir assemblies to the sprinkler nozzle so that water can be supplied at the fire site without a human operator remaining present at the fire site.

32. A portable water reservoir comprising:
a substantially rigid support frame that can be collapsed during transport and assembled at a desired location;
a waterproof fabric suspended from the support frame so as to enable water storage; and
a plurality of connection ports within the waterproof fabric to connect one or more additional reservoirs and allow water to flow between the connected reservoirs for providing an aggregate volume of water.
